(19) United States
(12) Patent Application Publication
(10) Pub. No.: US 2015/0125334 A1
(43) Pub. Date: May 7, 2015

(54) Materials and Process Using a Three Dimensional Printer to Fabricate Sintered Powder Metal Components

(71) Applicant: American Hakko Products, Inc., Valencia, CA (US)

(72) Inventors: Takashi Uetani, Osaka (JP); Chris Stuber, Valencia, CA (US)

(73) Assignee: American Hakko Products, Inc., Valencia, CA (US)

(21) Appl. No.: 14/070,219

(22) Filed: Nov. 1, 2013

(51) Int. Cl. B22F 3/10; B23K 3/06; B23K 3/02; B22F 5/10; B22F 7/02

(52) U.S. Cl. CPC B22F 3/10; B22F 5/10; B22F 7/02; B23K 3/025; B23K 3/0607; B22F 2005/002
USPC 419/6; 419/5; 419/36

(57) ABSTRACT

A process and materials are disclosed to enable the formation of metal powder-polymer/plastic preform articles by three dimensional printing a green state article, debinding the polymer/plastic from the metal powder, and sintering the article to a final shape.

### BACKGROUND OF THE INVENTION

In many fields it is beneficial for companies to be able to rapidly form prototypes and samples of products for customer presentations. To address this need companies have developed rapid prototyping techniques to produce prototype articles and small quantities of semi-functional or even functional parts from computer-generated design data using either a selective laser sintering process or a three-dimensional printing process. These techniques are similar to the extent that they both use layering techniques to build three-dimensional articles. Both methods form successive thin cross-sections of the desired article. The individual cross-sections are formed by bonding together adjacent grains of a granular material on a generally planar surface or a bed of the granular material. Each layer is bonded to a previously formed layer to form the desired three-dimensional article at the same time as the grains of each layer are bonded together. The process may create parts directly from computer-generated design data and can produce parts having complex geometries.

One technique for building a three dimensional item is described in U.S. Pat. No. 5,204,055. The method involves applying a layer of a ceramic powder to a surface using a counter-roller. After the ceramic powder is applied to the surface, an ink-jet print head delivers a liquid or colloidal binder in a predetermined pattern to the layer of powder. The binder infiltrates into gaps in the powder material and hardens to bond the powder material into a solidified layer. The hardened binder also bonds each layer to the previous layer. After the first cross-sectional portion is formed, the previous steps are repeated, building successive cross-sectional portions until the final article is formed and the excess powder is removed. The process of the U.S. Pat. No. 5,204,055 patent and further evolutions of rapid prototyping products have been characterized as additive manufacturing, a generic term used to describe the process by which successive layers of a structure, device or mechanism are formed, and in which in each layer may be formed by a direct write method. The term “additive” is used to contrast conventional manufacturing processes such as lithography, milling, turning etc., in which material from a solid layer or object is taken away or removed.

In direct write or additive manufacturing processes, the materials may be referred to as inks or feedstocks even though the actual form of the material may comprise a wide range of powders, suspensions, plasters, colloids, solutes, vapors etc., which may be capable of fluid flow and which may be applied in pastes, gels, sprays, aerosols, liquid droplets, liquid flows, and other means. Once applied, the ink or feedstock material may be fixed by curing, consolidating, sintering or drying, which may involve the application of heat or light to change the state of the ink or feedstock material to a solid phase. The object or structure (i.e. the three-dimensional object) on which the deposition is performed is referred to in the art by the term “substrate”, and this is the sense of the term as used in the present specification. The deposited ink or feedstock, once fixed on the substrate, may form a “green state” article if it requires subsequent processing to become a solid component or part of a structure.

A specific form of direct write or additive manufacturing process uses a 3D printer that embodies Fused Deposition Modeling (FDM) Technology to build 3D parts layer-by-layer by heating thermoplastic feedstock material to a semi-liquid state and extruding it to computer-controlled locations. Conventional FDM uses two materials to execute a print job: modeling material, which constitutes the finished piece, and support material, which acts as type of scaffolding or support when an open space is to be formed inside of or below a section of the article. The feedstocks are provided in the form of filaments that are fed from the 3D printer's material supply canister to the print head. An example of a FDM print head and a feedstock supply method are provided in U.S. Pat. Nos. 7,625,200 and 7,896,209 assigned to Stratasys, hereby incorporated by reference. The print head is mounted on a traveling structure so that it may move in both the X and Y coordinates, i.e. horizontally and vertically, depositing material to complete each layer before the base or substrate moves vertically down the Z axis and the next deposition layer begins.

Polymer jet 3D printing is similar to inkjet document printing but instead of jetting drops of ink onto paper, Polymer jet 3D printers jet layers of liquid photopolymer onto a build tray and cure the photopolymer with an ultraviolet (UV) light. The layers build up one at a time to create a 3D model or prototype. Fully cured models can be handled and used immediately, without additional post-curing processes. Along with the selected model materials, the 3D printer also jets a gel-like support material specially designed to uphold overhangs and complicated geometries. The gel-like support material may be removed by hand or with water upon completion of the fabrication of the article. Polymer jet 3D printing technology has certain advantages for rapid prototyping, including high quality and speed, high precision, and a wide variety of feedstock materials. In addition, some Polymer jet 3D Printers can jet multiple feedstock materials in a single print run to selectively position multiple materials in one printed prototype and even combine two materials to create composite materials.

Using either the FDM or polymer jet 3D printer technologies, current 3D printing enables the formation of three-dimensional plastic parts in one production operation. Depending upon the feedstock materials used, the articles may be formed to a solid shape or they may require secondary processing to obtain a final solid state. However, both technologies still have a disadvantage as compared to the much more expensive and time consuming powder bed laser sintering technologies that have been used to form net shape ceramic articles, in that the resulting articles produced by the present FDM or polymer jet 3D printer technologies are plastic or plastic-like articles, as opposed to ceramics or metal articles.

### SUMMARY OF THE INVENTION

The present invention is directed to a method, process and feedstock material for producing sintered powder metallic parts according to computer-generated design data, starting with the fabrication of a powder metal and polymer/plastic binder green state article using a 3D printer. After formation of the green state article, the article is subjected to de-binder processing to remove the polymer/plastic binder component, and then sintering to fuse the powder metal to a net shape article. Appropriate selection of powder metal grain size and ratios of metal to binder allows for appropriate green part strength, minimal net shape shrinkage in the sintering process, and engineered mechanical characteristics and properties of the final metal article. These features and the materials and process contemplated herein allow the rapid prototyping of complex three-dimensional net shape metallic articles that may be used as prototypes or in specialized situations as limited production run components.

A preferred or exemplary embodiment is discussed in the context of forming various types of soldering iron tips and de-soldering nozzles that may be used as prototypes or for limited production parts for use with a soldering/de-soldering station. To exemplify the ability to uniquely engineer the metal article, composite soldering tips and composite de-soldering nozzles are disclosed. Soldering tips formed by powder metal injection molding and brazing processes, as well as the component materials for fabricating the soldering tips, are described in U.S. Pat. No. 7,030,339, herein incorporated by reference. While soldering tips and de-soldering nozzles are disclosed as the exemplary final article, the feedstock materials and processes described herein may be used to fabricate other articles without significant deviation from the disclosed concepts.

### BRIEF DESCRIPTION OF THE FIGURES

The following drawings are not necessarily to scale, emphasis instead being placed generally upon illustrating the principles of the invention. The foregoing and other features and advantages of the present invention, as well as the invention itself, will be more fully understood from the following description of preferred and exemplary embodiments, when read together with the accompanying drawings, in which:

FIG. 1 is a schematic view of the steps of the process of the present invention used to formulate a powder metal part;

FIG. 2 is a cross sectional view of a first soldering iron tip formed from the process of FIG. 1;

FIG. 3 is a cross sectional view of a first de-soldering nozzle formed from the process of FIG. 1;

FIG. 4 is a cross sectional view of a second soldering iron tip formed from the process of FIG. 1;

FIG. 5 is a cross sectional view of a second de-soldering nozzle formed from the process of FIG. 1;

FIG. 6 is a cross sectional view of another soldering iron tip formed from the process of FIG. 1;

FIG. 7 is a cross sectional view of a composite de-soldering nozzle formed from the process of FIG. 1;

FIG. 8 is a cross sectional view of another composite soldering iron tip formed from the process of FIG. 1; and

FIG. 9 is a cross sectional view of another composite soldering iron tip formed from the process of FIG. 1.

### DETAILED DESCRIPTION

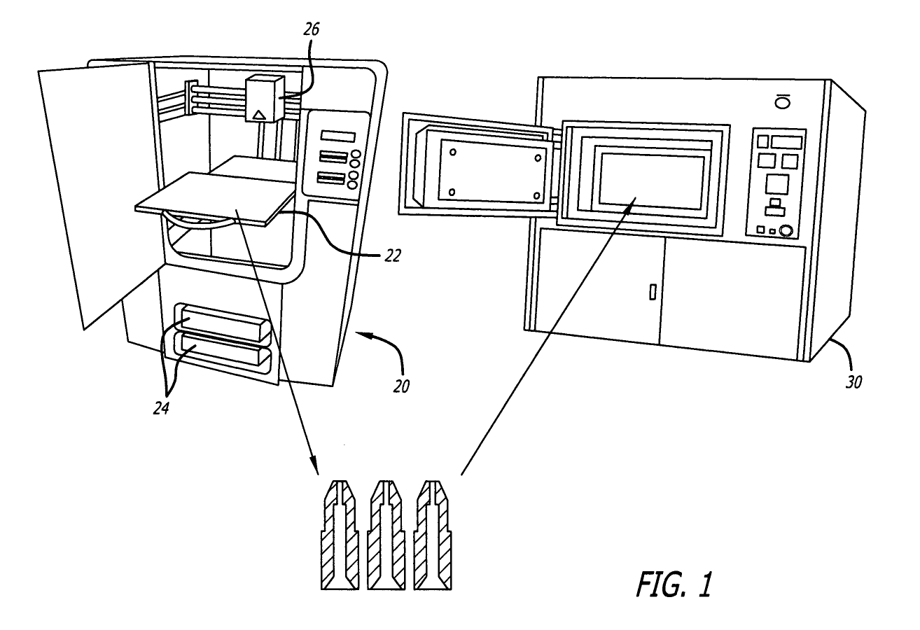

FIG. 1 depicts the steps of the process of the present invention used to formulate a powder metal article 10, in particular in the example shown a soldering tip. In the build process depicted in FIG. 1, a FDM or polymer jet 3D printer 20, provided with a computer-generated design of the three dimensional structure of an articles 10, fabricates the articles 10 in a green state by the successive deposition of layers of feedstock material on the platform 22 of the 3D printer 20. The configuration of the 3D printer 20 may be similar to the small size “uPrint” 3D printers from Stratasys based in Eden Prairie, Minn., “MakerBot Replicator” 3D printer from MakerBot Industries, LLC of Brooklyn, N.Y., or the “Cube” 3D printer from 3D Systems Corporation of Rock Hills, S.C., or the large size 3D Printers such as the “Dimension Elite” from Stratasys.

The powder metal-plastic binder material may be provided to the 3D printer in a solid or semi-solid state depending on the type of feedstock material that the 3D printer is configured to utilize. In the most common 3D Printers presently available, the feedstock is presented to the print head in the form of a filament. The filament itself is made using an extrusion molding process. By way of example, a metal powder or powder blend having a particle size in the range of between 1 μm and 50 μm is blended with a polymer/plastic binder to a uniform consistency in an extrusion molding machine under heat and pressure and then the blended material is extruded to form a filament suitable for use in a Fused Deposition Modeling or polymer jet 3D Printer.

In the print head the powder metal-polymer/plastic binder material filament is either heated to the melt point or at least soften the polymer/plastic binder material but not to a temperature sufficient to melt the metal powder, such that the polymer/plastic binder material forms a thin coating layer on the uniformly dispersed metal powder particles and the polymer/plastic binder material bonds to the platform of the 3D Printer or the previously deposited layer either as a result of cooling upon contact or with the use of irradiation or ultraviolet light to cure the photopolymer binder. Alternatively, in the print head the feedstock powder metal-polymer/plastic binder material may be mixed with an activator or hardening agent that will cause the polymer/plastic binder material to harden after ejection from the print head upon contacting the platform of the 3D Printer or the previously deposited layer.

In accordance with the 3D printing method using the materials system of the present invention, a first layer of the powder metal-plastic binder material 24 is applied to a linearly and vertically movable platform 22 of the 3D printer 20, preferably within an enclosure 26. The layer of material 24 may be formed in any suitable manner, for example using an ink-jet style nozzle 28 to deliver a partially liquefied feedstock to selected locations in a two-dimensional pattern. After each layer of material is applied, the platform 22 descends vertically away from the nozzle 28, and another layer is then applied atop the prior layer. According to the printing method, the material 24 is delivered atop the prior layer in a predetermined two-dimensional pattern, using a convenient mechanism such as a drop-on-demand print head driven by software in accordance with article model data from a computer-assisted-design (CAD) system.

After the article 10 is fabricated in the 3D Printer 20, it is in a green state wherein the metal powder is dispersed and held in the polymer/plastic matrix. The green state article 10 is then transferred to a debinding station, wherein the polymer/plastic binder material is removed. The polymer/plastic binding material may be removed by known techniques depending upon the particular polymer/plastic binding material selected, including for example by submersion in a solvent or water bath or heating to gasify the polymer/plastic binder.

After the debinding step, the article 10 undergoes a sintering process in a sintering furnace 30. A thermal debinding process may be carried out in the same furnace used in the sintering step, or in a separate device for example when the debinding step is carried out by submersion. In the sintering process, the article is subjected to a heat profile intended to cause the metal powder to fuse into a solid without warping or distortion such that the net shape of the article changes only in size relative to the green state article. During the sintering process, the metal powder particles coalesce together to form a substantially continuous solid metal phase. In some forms of the invention, the sintering process is carried out a temperature at or above the melting point temperature of a metal powder representing a small fraction of the overall metal powders such that liquid phase sintering fuses metal particles having a higher melting point temperature together. Thus, for example, copper or silver powders may be present in a fractional amount as compared to a predominantly iron powder matrix. During the sintering process, the green state article undergoes about 15 to 25 percent shrinkage in all dimensions.

It is contemplated that the interstitial porosity may be substantially eliminated in the sintering process, or that the sintering process will be completed when the interstitial porosity reaches a preferred or selected level for the intended use of the article. For some applications such as a soldering tip, it will be preferable to have the sintering step fuse the metal powder to a minimal residual porosity which generally requires higher sintering temperatures. However, in other applications such as a filter or metal reactor element to be placed in a fluid flow passageway, it may be preferable to have the sintering step fuse the metal powder to a very high residual porosity and permeability in a lower temperature sintering process (e.g. 400° C. to 600° C. for copper, 500° C. to 800° C. for an iron alloy) so as to allow passage of the fluid through the filter or metal reactor.

The metal powder is preferably one or more metal powders selected from the group consisting of iron, silver, silver alloy, copper, copper alloy, nickel, cobalt, chromium, aluminum, and titanium. The metal powder granule size may be selected so as to both minimize the erosive effect on the printer nozzle by having the particle size as small as possible, while maximizing the amount of metal powder as compared to the amount of binder in the feedstock to minimize shrinkage during debinding and sintering. Accordingly, the granular size for the metal powder is less than 50 microns (50 μm) and preferably the granular size is in the range of between 1-20 microns (1-20 μm) in diameter. The metal powder may have a uniform particle size or a distribution of particle sizes to maximize the amount of powder in the green state article. Preferably, for predominantly iron based soldering tip applications, the iron powder should be of a high purity, for example at least 98% to 99.9% purity with minimal carbon, oxygen, nitrogen or hydrogen contaminates. The metal particle shape may be generally spherical or irregularly shaped, which may be desirable for handling the green parts. The specific metal powder employed depends upon the nature of the part to be prepared by the present process.

For convenience, the foregoing description provides that the binder is a polymer/plastic material. Preferably, the binder is either polyethelyne or polypropylene and wax to enhance flow properties. Alternative and potentially suitable plastic materials presently contemplated for 3D printing include acrylic butadiene styrene (ABS), polylactic acid or polylactide (PLA), polycarbonates and polyvinyl acetate (PVA) may be used as the binder. Additionally, the plastic binder may be a sinterable thermoplastic polymers such as, but not limited to, polyethylene-imine, polystyrene, polymethylmethacrylate, polytetrafluoroethylene, polysaccharides, polymers and copolymers of acrylic and methacrylic acid and their esters, polyvinyl chloride, polyethylene carbonate and polystyrene, and mixtures thereof. The polymeric material can be thermoplastic or thermosetting, or mixtures of thermoplastic and thermosetting materials can be employed. The binder can include one or more additives such as wax to improve flow characteristics and shape retention. The amount of binder in the feedstock may be in the range of from about 35 to 45 by volume percentage, based on the total composition of the feedstock, and preferably about 40 volume percent for soldering iron tips and desoldering nozzles. The green state article will shrink in size during the debinding and sintering processes. To reduce the amount of shrinkage such that the green state article is as close to the net final shape as possible, it is preferable to minimize the amount of binder required while allowing fabrication using the 3D Printer and maintain the necessary green strength. Thus, the amount of binder mixed with the metal powder is preferable not more than 45 percent by volume.

To further illustrate and describe the process for forming a sintered powder metal article, the above described process is further described in connection with fabricating various types of soldering tips and de-soldering nozzles that may be used with a soldering/de-soldering workstation. An exemplary soldering and de-soldering workstation is the “Hakko FM-205” sold by Hakko Corporation of Valencia, Calif.

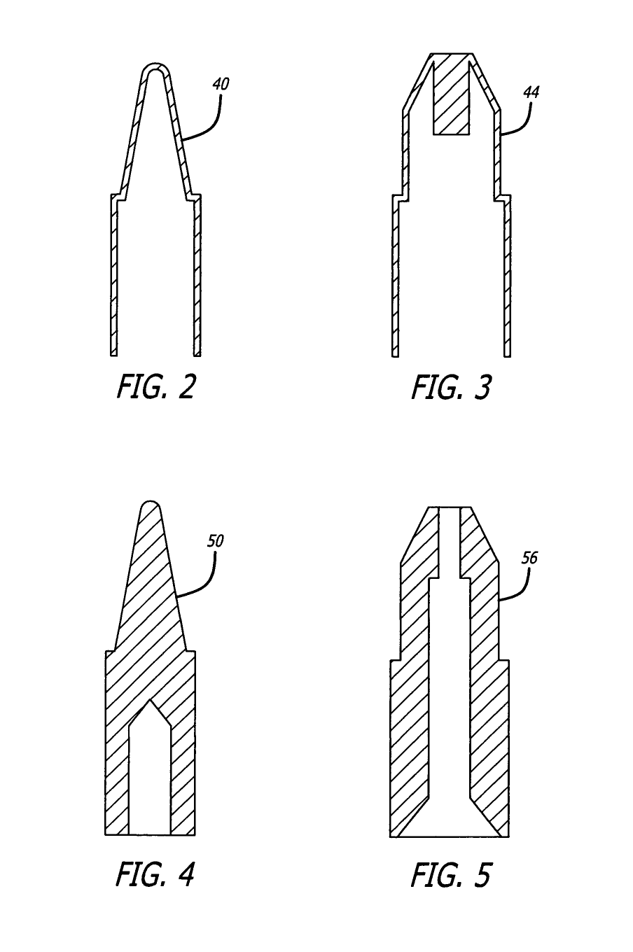

FIG. 2 provides a cross sectional view of a soldering tip 40 made of iron (Fe) or an iron, nickel (Ni), and/or cobalt (Co) alloy according to the present invention. FIG. 3 provides a cross sectional view of a de-soldering nozzle 44 made according to the present invention. For the configurations of FIGS. 2 and 3, an iron powder, iron alloy powder or iron, nickel and/or cobalt powders having a particle size in the range of between 1 μm and 50 μm and preferably between 1 μm and 20 μm may be blended with a suitable polymer/plastic binder to a uniform consistency in an extrusion molding machine under heat and pressure and then the blended material is extruded to form a filament suitable for use in a Fused Deposition Modeling (FDM) 3D Printer. For an iron-nickel alloy, the nickel content should be less than 50% by weight and preferably in the 1-10% by weight range. For an iron-cobalt alloy, the cobalt should be less than 20% by weight and preferably in the 0.5% to 10% by weight range with about 3% cobalt providing optimal corrosion resistance at high soldering temperatures. Sintering additives such as copper or silver may be included in the metal powders in a range of between 1% and 10% by weight, and preferably in the 1% to 3% range to promote liquid phase sintering. Other sintering additives, for example carbon in an amount of 0.3% to 2% by weight may also be used for soldering tip applications.

The 3D printer is provided with a three-dimensional computer aided design (CAD) drawing of the soldering tip or de-soldering nozzle. The 3D Printer forms the green state article having the cross sectional shape shown in FIG. 2 or FIG. 3. After the green state article is formed, it is removed from the 3D Printer and moved to a de-binder station where the polymer/plastic binder is removed using a solvent, water or heat. Upon completion of the de-binder step, the article is subject to a sintering process, either in the same chamber used for the de-binder step or in a separate chamber.

A thermal de-binding process and the sintering process may be completed by placing the article formed via the 3D Printer into a non-reactive atmosphere furnace. The polymer/plastic material of the green state article is removed by heating the green article to a temperature exceeding at least 400° C., and preferably exceeding 500° C. for between 20 and 60 minutes in a non-reactive gas such as Nitrogen atmosphere. A four percent Hydrogen atmosphere may be used for some binding materials. The process of heating and then cooling the article in the furnace may take about three hours.

Following completion of the de-binder step, an iron powder metal article, or an iron-nickel alloy or an iron-cobalt alloy may be sintered under a gradually increasing temperature up to at least 1100° C. and preferably in the range of 1200° C. to about 1350° C. at which it is maintained for between about 20 to 30 minutes. If the iron or iron based alloy includes copper metal particles sintering agent in the amounts described above the sintering temperature should not significantly exceed 1,083° C. And, an iron or iron based alloy including silver metal particles as a sintering agent in the amounts described above the sintering temperature should not significantly exceed 961° C. In addition to variations resulting from the composition of the metal particles, the sintering time and temperature is also dependent upon the size of the article and the number of articles being sintered in a single batch. Upon completion of the sintering process, the formed article such as the soldering tip or de-soldering nozzle is removed from the furnace and allowed to cool.

FIG. 4 provides a cross sectional view of a soldering tip 50 made of copper or a primarily copper alloy according to the present invention. FIG. 5 provides a cross sectional view of a de-soldering nozzle 56 made of copper or a primarily copper alloy according to the present invention. For the configurations of FIG. 4 and FIG. 5, a copper powder having a particle size in the range of between 1 and 20 μm is blended with a polymer/plastic binder to a uniform consistency in an extrusion molding machine under heat and pressure and then the blended material is extruded to form a filament suitable for use in a FDM 3D Printer. The 3D printer is provided with a three-dimensional CAD drawing of the soldering tip or de-soldering nozzle. The 3D Printer forms the green state article having the cross sectional shape shown in FIG. 4 or FIG. 5. After the green state article is formed, it is removed from the 3D Printer and moved to a de-binder station where the polymer/plastic binder is removed using a solvent, water or heat. Optionally, the green state article may be subjected to an electric current to fuse the copper powder particles prior to or during the de-binder process. Upon completion of the de-binder step, the article is subject to a sintering process, either in the same chamber used for the de-binder step or in a separate chamber.

The de-binding and sintering process may be completed by placing the green state article formed via the 3D Printer into a controlled atmosphere furnace. The polymer/plastic material of the green state article is removed by heating the green article to a temperature exceeding at least 400° C., and preferably exceeding 500° C. for between 20 and 60 minutes in a non-reactive gas atmosphere. Following completion of the de-binder step, the powder metal article is heated under a gradually increasing temperature and vacuum to a sintering temperature of at least 700° C. and preferably in the range of from 800° C. to 1000° C., at which it is maintained for between about 20 to 60 minutes. For the green state article formed solely or primarily of copper, the sintering temperature cannot exceed the 1,083° C. melting point temperature of copper, and preferably it should not exceed 1050° C. Upon completion of the sintering process, the formed soldering tip or de-soldering nozzle is removed and allowed to cool.

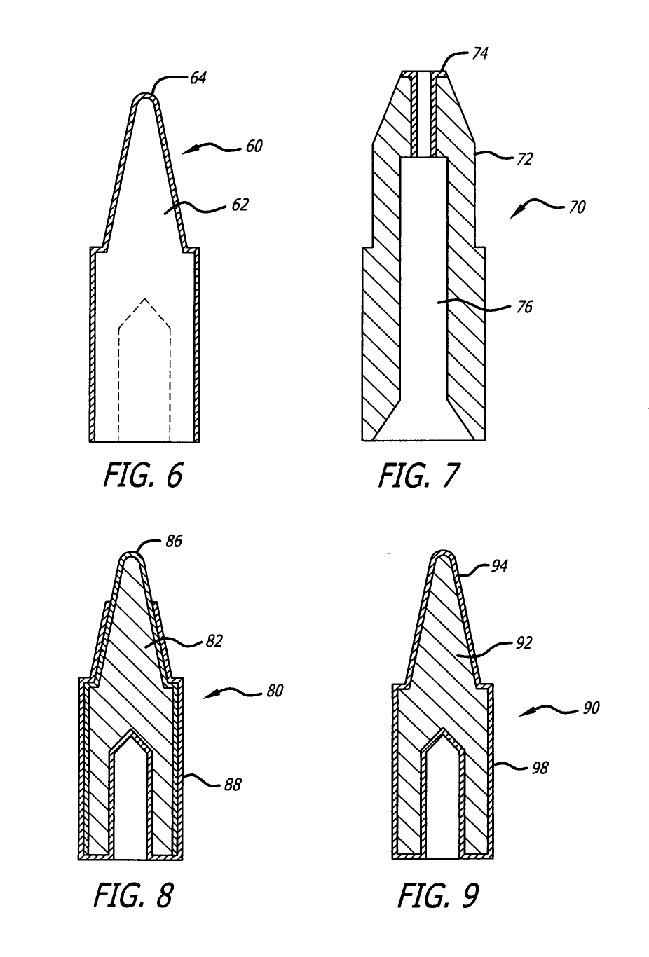

FIG. 6 provides a cross sectional view of another type of composite soldering tip 60 made of sintered copper, copper alloy, silver or silver alloy interior core 62 and a sintered iron or iron, nickel and/or cobalt exterior layer 64 made according to modified version of the present invention requiring a 3D Printer having the capability to work with and deposit at least two feedstock filaments. An example of a print head capable of handling two feedstock materials is disclosed in U.S. Pat. No. 7,604,470 assigned to Stratasys, hereby incorporated by reference. The first feedstock comprises a copper, copper alloy, silver or silver alloy powder having a particle size in the range of between 1 μm and 50 μm, and preferably in the range of from 1 μm and 20 μm, blended with a polymer/plastic binder to a uniform consistency in an extrusion molding machine under heat and pressure and then the blended material is extruded to form a filament suitable for use in a FDM 3D Printer. The second feedstock comprises an iron, nickel and/or cobalt powder(s) having a particle size in the range of between 1 μm and 50 μm and preferably less than 20 μm for the iron or nickel powders and in the range of between 1 and 50 μm and preferably less than 20 μm for the cobalt powder blended with a polymer/plastic binder to a uniform consistency in an extrusion molding machine under heat and pressure and then the blended material is extruded to form a filament suitable for use in a FDM 3D Printer.

For an iron-nickel alloy, the nickel content should be less than 50% by weight and preferably in the 1-10% by weight range. For an iron-cobalt alloy, the cobalt should be less than 20% by weight and preferably in the 0.5% to 10% by weight range with about 3% cobalt providing optimal corrosion resistance at high soldering temperatures. Preferably, the iron and nickel powders may be blended in an iron (Fe)/nickel ratio of from about 90%-99.9% iron (Fe) by weight and the balance nickel. The iron and cobalt powders may be blended in an iron/cobalt ratio of from 90%-99.9% iron (Fe) by weight and the balance cobalt. The iron, nickel and cobalt powders may be blended in iron/nickel/cobalt ratios of from about 90%-98% iron (Fe), 0.1%-9.9% nickel and the balance copper, by weight.

For the exterior layer 64, covering a copper core, including copper as a sintering additive with the iron powders forming the exterior layer 64 in a range of between 1% and 10% by weight, and preferably in the 1% to 3% range may promote liquid phase sintering as well as bonding and heat transfer from the core 62 to the exterior layer 64. If the core 62 is formed of silver, then silver partials should be used as the sintering additive to the iron particles forming the exterior layer 64.

The two feedstock 3D printer is provided with a three-dimensional CAD drawing of the composite soldering tip. The 3D Printer forms the green state article having the cross sectional shape shown in FIG. 6 by using the first feedstock material to form the inner core and the second feedstock material to form the outer layer. After the green state article is formed, it is removed from the 3D Printer and moved to a de-binder station where the polymer/plastic binder is removed using a solvent, water or heat, and then to a heat station for sintering. By way of example, the de-binding and sintering process may be completed by placing the green state article into a controlled atmosphere furnace. The polymer/plastic binder material of the green state article is removed by heating the green article to a temperature exceeding at least 400° C., and preferably exceeding 500° C. for between 20 and 60 minutes in a non-reactive gas atmosphere. Following completion of the de-binder step, for a copper core 62 the powder metal article is heated under a gradually increasing temperature and vacuum to a sintering temperature of at least 900° C. and less than 1082° C. at which it is maintained for between about 20 to 60 minutes. For a silver core 62, the powder metal article is heated under a gradually increasing temperature and vacuum to a sintering temperature of at least 800° C. and less than 960° C. at which it is maintained for between about 20 to 60 minutes. Upon completion of the sintering process, the formed soldering tip or de-soldering nozzle is removed and allowed to cool.

FIG. 7 provides a cross sectional view of a composite de-soldering nozzle 70 having a main body 72 made of sintered copper, copper alloy, silver or silver alloy and an end cap 74 and a hollow core 76 made of a sintered iron, or an iron nickel and/or cobalt alloy material made according to a modified version of the present invention also requiring a 3D Printer having the capability to work with and deposit at least two feedstock filaments. To form the composite de-soldering nozzle of FIG. 7, the copper, copper alloy, silver or silver alloy powder blended with a polymer/plastic binder feedstock described above may be used as the first feedstock and the iron, nickel and/or cobalt powder(s) blended with a polymer/plastic binder feedstock described above may be used as the second feedstock.

The two feedstock 3D printer is provided with a three-dimensional CAD drawing of the composite de-soldering nozzle of FIG. 7. The 3D Printer forms the green state article having the cross sectional shape shown in FIG. 7 by using the first feedstock material to form the main body and the second feedstock material to form the end cap having an axial bore there-through. After the green state article is formed, it is removed from the 3D Printer and moved to a de-binder station where the polymer/plastic binder is removed using a solvent, water or heat, and then to a heat station for sintering. By way of example, the de-binding and sintering process may be completed by placing the green state article into a controlled atmosphere furnace. The polymer/plastic binder material of the green state article is removed by heating the green article to a temperature exceeding at least 400° C., and preferably exceeding 500° C. for between 20 and 60 minutes in a non-reactive gas atmosphere. Following completion of the de-binder step, for a copper or copper alloy based main body 72, the powder metal article is heated under a gradually increasing temperature and vacuum to a sintering temperature of at least 900° C. and less than 1082° C. at which it is maintained for between about 20 to 60 minutes. For a silver or silver alloy based main body 72, the powder metal article is heated under a gradually increasing temperature and vacuum to a sintering temperature of at least 700° C. and less than 960° C. at which it is maintained for between about 20 to 60 minutes. Upon completion of the sintering process, the formed soldering tip or de-soldering nozzle is removed and allowed to cool.

FIG. 8 provides a cross sectional view of another composite soldering tip 80 having a main body 82 made from sintered copper, copper alloy, silver or silver alloy, a main body liner 84, an exposed end cap 86 made from a sintered iron, nickel and/or cobalt material, and an exterior wrap layer 88 made from a chromium, aluminum, titanium or graphite material made according to a modified version of the present invention requiring a 3D Printer having the capability to work with and deposit at least three feedstock filaments. To form the composite soldering tip of FIG. 8, the copper, copper alloy, silver or silver alloy powder blended with a polymer/plastic binder feedstock described above may be used as the first feedstock and the iron, nickel and/or cobalt powder(s) blended with a polymer/plastic binder feedstock described above may be used as the second feedstock. The third feedstock comprises a chromium, aluminum, titanium or graphite powder having a particle size in the range of between 1 and 20 μm blended with a polymer/plastic binder to a uniform consistency in an extrusion molding machine under heat and pressure and then the blended material is extruded to form a filament suitable for use in a FDM 3D Printer.

The three feedstock 3D printer is provided with a three-dimensional CAD drawing of the composite soldering tip of FIG. 8. The 3D Printer forms the green state article having the cross sectional shape shown in FIG. 8 by using the first feedstock material to form the main body and the second feedstock material to form the main body liner and exposed end cap, and the third feedstock material to form the exterior wrap layer. After the green state article is formed, it is removed from the 3D Printer and moved to a de-binder station where the polymer/plastic binder is removed using a solvent, water or heat, and then to a heat station for sintering.

FIG. 9 provides a cross sectional view of another alternative composite soldering tip 90 having a main body 92 made from sintered copper, copper alloy, silver or silver alloy, an exposed end cap 94 made from a sintered iron, nickel and/or cobalt material, and an exterior wrap layer 98 made from a chromium, aluminum, titanium or graphite material made according to a modified version of the present invention requiring a 3D Printer having the capability to work with and deposit at least three feedstock filaments. The first, second and third feedstocks used to construct the alternative composite soldering tip are the same as those described above. The three feedstock 3D printer is provided with a three-dimensional CAD drawing of the alternative composite soldering tip of FIG. 9. The 3D Printer forms the green state article having the cross sectional shape shown in FIG. 9 by using the first feedstock material to form the main body and the second feedstock material to form the exposed end cap, and the third feedstock material to form the exterior wrap layer. After the green state article is formed, it is removed from the 3D Printer and moved to a de-binder station where the polymer/plastic binder is removed using a solvent, water or heat, and then to a heat station for sintering.

By way of example, the de-binding and sintering process for the composite soldering tips of FIG. 8 and FIG. 9 may be completed by placing the green state article into a controlled atmosphere furnace. The polymer/plastic binder material of the green state article is removed by heating the green article to a temperature exceeding at least 400° C., and preferably exceeding 500° C. for between 20 and 60 minutes in a non-reactive gas atmosphere. Following completion of the de-binder step, the powder metal article is heated under a gradually increasing temperature and vacuum to a sintering temperature of at least 800° C. at which it is maintained for between about 20 to 60 minutes. Upon completion of the sintering process, the formed composite soldering tip is removed and allowed to cool.

With respect to the iron alloy components of the articles of FIGS. 7-9, for an iron-nickel alloy, the nickel content should be less than 50% by weight and preferably in the 1-10% by weight range. For an iron-cobalt alloy, the cobalt should be less than 20% by weight and preferably in the 0.5% to 10% by weight range with about 3% cobalt providing optimal corrosion resistance at high soldering temperatures. Preferably, the iron and nickel powders may be blended in an iron (Fe)/nickel ratio of from about 90%-99.9% iron (Fe) by weight and the balance nickel. The iron and cobalt powders may be blended in an iron/cobalt ratio of from 90%-99.9% iron (Fe) by weight and the balance cobalt. The iron, nickel and cobalt powders may be blended in iron/nickel/cobalt ratios of from about 90%-98% iron (Fe), 0.1%-9.9% nickel and the balance copper, by weight. The iron or iron alloy components may also include small amounts (1% to 3% by weight) of copper or silver as a sintering agent to reduce corrosion and aid bonding to the primarily copper or silver components of the articles.

Those skilled in the art will readily appreciate that the disclosure herein is meant to be exemplary and actual parameters depend upon the specific application for which the process and materials of the present invention are used. It is, therefore, to be understood that the foregoing embodiments are presented by way of example only and that, within the scope of the appended claims and equivalents thereto; the invention may be practiced otherwise than as specifically described.

What is claimed is:

1. A process for forming a soldering tip or de-soldering nozzle comprising the steps of:
formulating at least one powder metal-plastic binder feedstock material suitable for use in a 3D printer in a solid or semi-solid state;
fabricating a green state article from said at least one powder metal-plastic binder feedstock in a 3D printer;
removing said green state article from said 3D printer and subjecting the green state article to a de-binding process;
sintering the de-binded article to fuse the powder metal to a final net shape.

2. The process of claim 1, wherein the step of formulating said at least one powder metal-plastic feedstock material further comprises:
combining one or more metal powders having a grain size in the range of 1 μm to 50 μm with a binder to a uniform consistency in an extrusion molding machine under heat and pressure;
extruding the blended material to form a filament suitable for use in said 3D printer.

3. The process of claim 2, wherein the step of combining one or more metal powders with said binder further comprises:
selecting the metal powder from the group consisting of iron, nickel, cobalt and copper, said metal powders having a grain size diameter less than 20 μm;
selecting the binder from the group consisting of polyethelyne and polypropylene; and
mixing about 35 to 45 by volume percentage binder and the balance metal powder.

4. The process of claim 1, wherein the de-binding process is carried out by submersion in a fluid bath to dissolve and remove the plastic binder.

5. The process of claim 1, wherein the de-binding process is carried out by heating to gasify the plastic binder.

6. The process of claim 5, wherein the thermal de-binding process comprises heating the green article to a temperature exceeding at least 400° C. for between 20 and 60 minutes in a non-reactive gas atmosphere furnace.

7. The process of claim 3, wherein the metal powder is copper and the sintering process comprises heating the green article to a temperature exceeding at least 700° C. for between 20 and 30 minutes in a non-reactive gas atmosphere.

8. The process of claim 3, wherein the metal powder is copper and the sintering process comprises heating the green article to a temperature in the range of between about 700° C. and about 1080° C. for between 20 and 30 minutes in a non-reactive gas atmosphere.

9. The process of claim 3, wherein the metal powder is iron and the sintering process comprises heating the green article to a temperature exceeding at least 1000° C. for between 20 and 30 minutes in a non-reactive gas atmosphere.

10. The process of claim 3, wherein the metal powder is iron and the sintering process comprises heating the green article to a temperature in the range of between about 1200° C. and about 1350° C. for between 20 and 30 minutes in a non-reactive gas atmosphere.

11. The process of claim 1, wherein during the sintering process the metal powder particles coalesce, to form a substantially continuous solid metal phase and the green state article undergoes about 15 to 25 percent shrinkage in all dimensions.

12. The process of claim 1, wherein the step of combining one or more metal powders with the binder further comprises:
selecting the metal powder from the group consisting of iron, silver, silver alloy, copper, copper alloy, nickel, cobalt, chromium, aluminum, and titanium;
selecting the binder from one or more of the group consisting of polyethelyne, polypropylene, acrylic butadiene styrene, polylactic acid or polylactide, polycarbonate, polyvinyl acetate, polyethylene-imine, polystyrene, polymethylmethacrylate, polytetrafluoroethylene, polysaccharides, polymers and copolymers of acrylic and methacrylic acid and their esters, polyvinyl chloride, polyethylene carbonate and polystyrene; and
mixing about 35 to 45 by volume percentage binder and the balance metal powder.

13. The process of claim 1, wherein the 3D printer is selected from the group consisting of fused deposition modeling 3D printer and polymer jet 3D printer.

14. The process of claim 1, wherein the step of formulating at least one powder metal-plastic binder feedstock material further comprises:
forming a first feedstock material from copper powder and a binder selected from the group consisting of polyethelyne and polypropylene and mixing about 35 to 45 by volume percentage binder and the balance copper powder;
forming a second feedstock material from iron powder and a binder selected from the group consisting of polyethelyne and polypropylene and mixing about 35 to 45 by volume percentage binder and the balance iron powder;
said first feedstock material and said second feedstock material being provided to said 3D printer to allow construction of a green state composite soldering tip having a core formed from said first feedstock material and an exterior layer formed from said second feedstock material.

15. The process of claim 14, further comprising:
de-binding said green state composite soldering tip comprises heating the green state composite soldering tip to a temperature exceeding at least 400° C. for between 20 and 60 minutes in a non-reactive gas atmosphere furnace; and
sintering the de-binded composite soldering tip comprises heating the green article to a temperature in the range of between about 700° C. and about 1080° C. for between 20 and 30 minutes in a non-reactive gas atmosphere.

16. The process of claim 1, wherein the step of formulating at least one powder metal-plastic binder feedstock material further comprises:
forming a first feedstock material from a metal powder selected from the group consisting of one or more of silver, silver alloy, copper, copper alloy, nickel, cobalt, chromium, aluminum, and titanium and combing said metal powder with a binder selected from the group consisting of polyethelyne and polypropylene and mixing about 35 to 45 by volume percentage binder and the balance metal powder;
forming a second feedstock material from iron powder and a binder selected from the group consisting of polyethelyne and polypropylene and mixing about 35 to 45 by volume percentage binder and the balance iron powder;
said first feedstock material and said second feedstock material being provided to said 3D printer to allow construction of a green state composite soldering tip having a core formed from said first feedstock material and an exterior layer formed from said second feedstock material.

17. The process of claim 16, further comprising:
de-binding said green state composite soldering tip comprises heating the green state composite soldering tip to a temperature exceeding at least 400° C. for between 20 and 60 minutes in a non-reactive gas atmosphere furnace; and
sintering the de-binded composite soldering tip comprises heating the green article to a temperature in the range of between about 700° C. and about 1080° C. for between 20 and 30 minutes in a non-reactive gas atmosphere.

18. The process of claim 1, wherein the step of formulating at least one powder metal-plastic binder feedstock material further comprises:
forming a first feedstock material from a metal powder selected from one or more of copper, copper alloy, silver or silver alloy and combining said metal powder with a binder selected from the group consisting of polyethelyne and polypropylene and mixing about 35 to 45 by volume percentage binder and the balance copper powder;
forming a second feedstock material from a metal powder selected from one or more of iron, nickel and/or cobalt powder and combining said metal powder with a binder selected from the group consisting of polyethelyne and polypropylene and mixing about 35 to 45 by volume percentage binder and the balance iron powder; and
said first feedstock material and said second feedstock material being provided to said 3D printer to allow construction of a green state composite soldering tip having a core formed from said first feedstock material and an exterior layer formed from said second feedstock material.

19. The process of claim 1, wherein the step of formulating at least one powder metal-plastic binder feedstock material further comprises:
forming a first feedstock material from a metal powder selected from one or more of copper, copper alloy, silver or silver alloy and combining said metal powder with a binder selected from the group consisting of polyethelyne and polypropylene and mixing about 35 to 45 by volume percentage binder and the balance copper powder;
forming a second feedstock material from a metal powder selected from one or more of iron, nickel and/or cobalt powder and combining said metal powder with a binder selected from the group consisting of polyethelyne and polypropylene and mixing about 35 to 45 by volume percentage binder and the balance iron powder;
forming a third feedstock material from a powder selected from one of more of chromium, aluminum, titanium and graphite powder and combining said powder with a binder selected from the group consisting of polyethelyne and polypropylene and mixing about 35 to 45 by volume percentage binder and the balance iron powder; and
said first feedstock material, said second feedstock material and said third feedstock material being provided to said 3D printer to allow construction of a green state composite soldering tip having a core formed from said first feedstock material, a main body liner and end cap formed from said second feedstock material and an exterior wrap, exposing only said end cap, formed from said third feedstock material.

20. The process of claim 1, wherein the step of formulating at least one powder metal-plastic binder feedstock material further comprises:
forming a feedstock material from iron powders combined with one or more of nickel or cobalt, blended in an iron/nickel ratio of from about 90%-99.9% iron by weight and the balance nickel or an iron/cobalt ratio of from 90%-99.9% iron by weight and the balance cobalt or blended in iron/nickel/cobalt ratios of from about 90%-98% iron, 0.1%-9.9% nickel and the balance copper, by weight.
